(19) United States
(12) Patent Application Publication
(10) Pub. No.: US 2008/0065479 A1
(43) Pub. Date: Mar. 13, 2008

(54) System and method for optimizing online advertisement auctions by applying linear programming using special ordered sets

(75) Inventors: John Anthony Tomlin, Sunnyvale, CA (US); Ralphe Wiggins, Los Gatos, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/520,304

(22) Filed: Sep. 12, 2006

(51) Int. Cl. G06Q 30/00

(52) U.S. Cl. 705/14

(57) ABSTRACT

An improved system and method for optimizing online advertising auctions is provided by applying linear programming using special ordered sets. A linear programming model using special ordered sets of bids may first be created offline for the web page placements of advertisements for advertising campaigns. An expected number of impressions of advertisements for alternative bid levels may be determined for web page placements for advertising campaigns for a time period. Ordered sets of bid levels may be generated for web page placements of advertising campaigns and linear programming may be applied to determine optimal bid values for web page placements of advertising campaigns. Branching and cutting techniques may also be applied to the special ordered sets of bid values to rapidly obtain an optimal bid value for each special ordered set. Advertising campaigns may be updated with the optimal bid values for bidding in an online advertising auction.

### FIELD OF THE INVENTION

The invention relates generally to computer systems, and more particularly to an improved system and method for optimizing online advertisement auctions by applying linear programming using special ordered sets.

### BACKGROUND OF THE INVENTION

Online auctions for placement of graphical advertisements on web pages have relied in the past on campaign managers to manage an online advertising campaign. A campaign manager may define a campaign for a customer that may include one or more individual campaign lines for each web page or web property. A campaign line may be defined by the following attributes: name of a campaign, placement of an advertisement on a web page, user target for displaying the advertisement, start date of campaign, stop date of the campaign, total budget of the campaign, cost charged to the customer per impression, family of graphical advertisements associated with the line and a bid amount for bidding to display a particular advertisement.

Campaign managers may monitor the campaign periodically using a monitoring tool or report that may include the bid amount and the number of impressions for a particular period. There may be various reporting tools summarizing the behavior of the campaign and may include a tool to change the value of a bid. The campaign manager may choose to change the bid amount to derive more revenue for the auctioneer. If the budget of the campaign for the period was exhausted, then the campaign manager may lower the bid amount with an expectation that the revenue for the auctioneer may be increased. Or if the number of impressions was too low, then the campaign manager may increase the bid amount unless the bid amount may exceed the cost charged to the customer per impression.

Unfortunately, this approach for managing the bid amount fails to predict or use forecast cost and revenue data for expected impressions. As a result, a bid may be set for more than may be necessary for a particular period. Moreover, the bid amounts may not be optimized to achieve an auctioneer's objective. For example, an auctioneer's objective may be to maximize revenue, maximize the number of impressions for a particular web property, maximize the number of impressions for particular campaigns, and so forth.

What is needed is a system and method that may optimize the objective for an online auctioneer while ensuring that spending for advertising campaigns remains within specified budget constraints. Such a system and method should be able to take into consideration the advertisement value and should be able to bid the minimal amount needed for the availability of advertisement positions on web pages.

### SUMMARY OF THE INVENTION

Briefly, the present invention may provide a system and method for optimizing online advertising auctions by applying linear programming using special ordered sets. In various embodiments, a server may include a model generator for creating a linear programming model using special ordered sets of bids for web page placements of advertisements for advertising campaigns. The server may also include an operably coupled linear programming analysis engine for optimizing bids offline for web page placements of advertisements for advertising campaigns. The server may then choose optimal bid values and may update the advertising campaigns with the optimal bid values for bidding in an online advertising auction.

The present invention may provide a framework for predicting the expected cost and revenue of estimated impressions that may appear throughout a period in order to optimize bids in auctions for increasing the revenue of an auctioneer. A linear programming model using special ordered sets of bids may first be created offline for the web page placements of advertisements for advertising campaigns. To do so, an expected cost and revenue of an expected number of impressions of advertisements may be determined for web page placements for advertising campaigns for a time period; a remaining budget of each advertising campaign may be calculated for web page placements; estimated click through rates may be determined for web page placements of advertisements for advertising campaigns for a time period; and an expected number of impressions of advertisements for alternative bid levels may be determined for web page placements for advertising campaigns for a time period. Ordered sets of bid levels may be generated for web page placements of advertising campaigns and linear programming may be applied to determine optimal bid values for web page placements of advertising campaigns. Branching and cutting techniques may also be applied to the special ordered sets of bid values to rapidly obtain an optimal bid value for each special ordered set. Advertising campaigns may be updated with the optimal bid values for bidding in an online advertising auction.

Advantageously, the present invention may effectively use a forecast of the expected cost and revenue of estimated impressions occurring throughout a period for optimizing the objective of an auctioneer. By optimizing bids of advertising campaigns for auctions, the present invention may also provide improved coverage of advertisements placed on web properties. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for optimizing online advertisement auctions by applying linear programming using special ordered sets, in accordance with an aspect of the present invention;

FIG. 3 is a flowchart for generally representing the steps undertaken in one embodiment for optimizing bids for online advertising auctions subject to campaign budget constraints, in accordance with an aspect of the present invention;

FIG. 4 is a flowchart for generally representing the steps undertaken in one embodiment for optimizing bids for online advertisement auctions subject to budget constraints by applying linear programming using special ordered sets, in accordance with an aspect of the present invention; and

FIG. 5 is a flowchart for generally representing the steps undertaken in one embodiment for applying linear programming using special ordered sets to determine the bid level for web page placements of advertisements for each campaign to provide optimal revenue, in accordance with an aspect of the present invention.

### DETAILED DESCRIPTION

### Exemplary Operating Environment

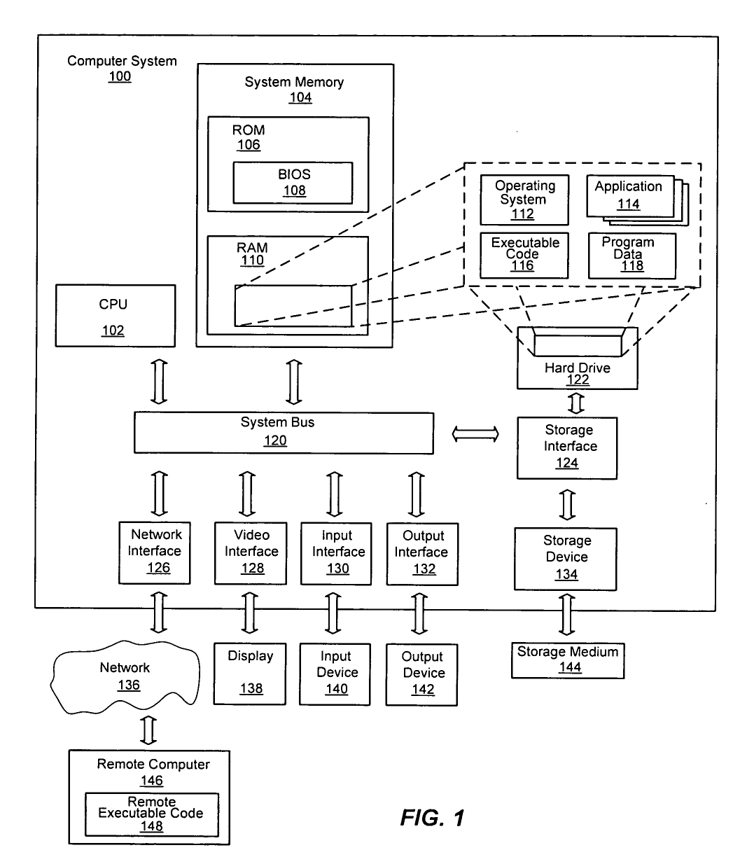

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Optimizing Online Advertisement Auctions by Applying Linear Programming Using Special Ordered Sets

The present invention is generally directed towards a system and method for optimizing online advertisement auctions by applying linear programming using special ordered sets. A linear programming model using special ordered sets of bid levels for web page placements of advertisements may be created offline for advertising campaigns. The model may include the estimated cost and revenue of an expected number of impressions occurring for a period in order to optimize bids in online advertising auctions. An expected number of impressions of advertisements for alternative bid levels may be used to generate special ordered sets of bid levels for web page placements of advertising campaigns. As used herein, a web page placement may mean a location on a web page designated for placing an advertisement for display. A web page placement may also include additional information such as a target group of visitors to be shown the advertisement.

Linear programming may then be applied to determine optimal bid values. Branching and cutting techniques may also be applied to the special ordered sets of bid values to rapidly obtain an optimal bid value for each special ordered set. As will be seen, advertising campaigns may be updated with the optimal bid values for bidding in an online advertising auction. As will be understood, the various block diagrams, flow charts and scenarios described herein are only examples, and there are many other scenarios to which the present invention will apply.

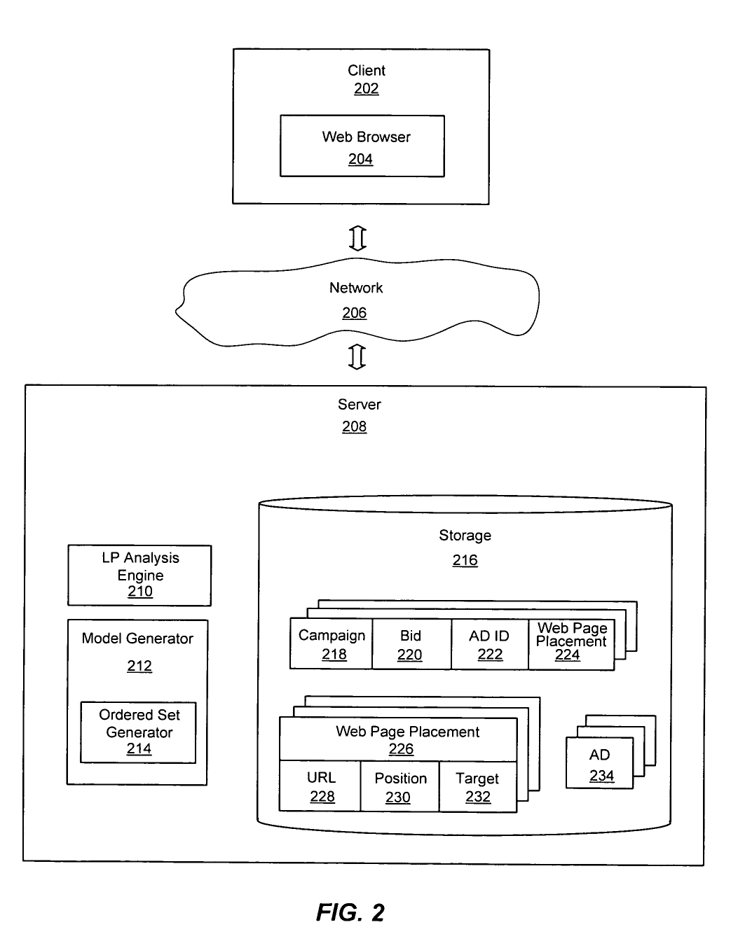

Turning to FIG. 2 of the drawings, there is shown a block diagram generally representing an exemplary architecture of system components for optimizing online advertisement auctions by applying linear programming using special ordered sets. Those skilled in the art will appreciate that the functionality implemented within the blocks illustrated in the diagram may be implemented as separate components or the functionality of several or all of the blocks may be implemented within a single component. For example, the functionality for the model generator 212 may be included in the same component as the linear programming analysis engine 210. Or the functionality of the ordered set generator 214 may be implemented as a separate component. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a web page requested by a user. The web browser may send a request for a web page to a web page server. When a request may be received by a web page server to serve a web page, the web page server may determine that the web page requested may include a web page placement for an advertisement. The web page server may then request an advertisement from an advertisement server to send to a web browser operating on a client so that the advertisement may be displayed as part of the web page by the web browser 204. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for optimizing online advertisement auctions using special ordered sets and may include services for providing optimized bid amounts for web page placements of advertisements for advertising campaigns. In particular, the server 208 may include a linear program analysis engine 210 for choosing bid amounts for advertisements for advertising campaigns and a model generator 212 for creating a linear programming model using special ordered sets of various bid amounts for web page placements of advertising campaigns. The model generator 212 may include a ordered set generator 214 for producing the special ordered sets of various bid amounts for web page placements of advertising campaigns. Each of these modules may also be any type of executable software code such as a kernel component, an application program, a linked library, an object with methods, or other type of executable software code.

The server 208 may be operably coupled to a database of information about advertising campaigns such as storage 216 that may include a campaign ID 218 that may be associated with a bid amount 220 for an advertisement referenced by advertisement ID 222 to be displayed according to the web page placement 224. The web page placement 224 may include a Uniform Resource Locator (URL) 226 for a web page, a position 228 for displaying an advertisement on the web page, and a target ID 230 for referencing a target or group of visitors that may be defined by a profile of characteristics that may match a visitor of the web page. In various embodiments, a target may be defined by demographic information including gender, age, or surfing behavior. Any type of advertisements 232 may be associated with an advertisement ID 222. Each campaign may have multiple campaign IDs 218 representing several bid amounts for various web page placements and the bid amounts for a campaign may be optimized using the linear programming model.

There may be many applications which may use the present invention for optimizing online advertisement auctions using special ordered sets. For example, online advertising applications may use the present invention to optimize bids for auctioning advertisement placement subject to bidders' budget constraints. Or online advertising applications may use the present invention to optimize bids for classes of advertisements to be shown to classes of users. For any of these applications, advertisement auctions may be optimized using special ordered sets to increase revenue of the auctioneer.

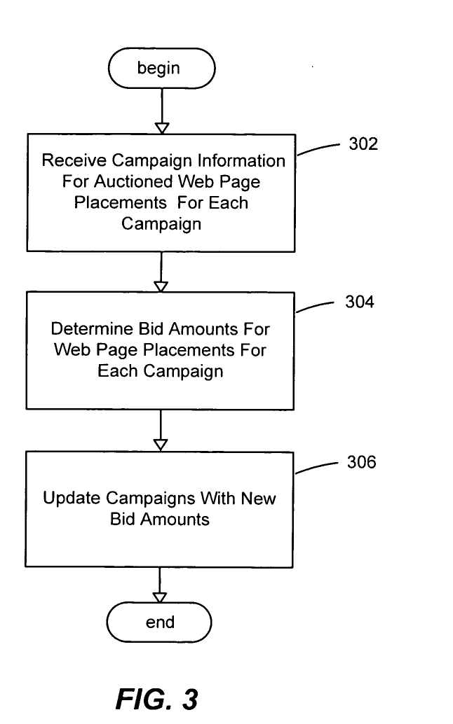

FIG. 3 presents a flowchart for generally representing the steps undertaken in one embodiment for optimizing bids for online advertising auctions subject to campaign budget constraints. At step 302, advertising campaign information for auctioned web page placements including the number of impressions, the bid amount and CTR may be received for each campaign for a time period. New bid amounts for each campaign may be generated at step 304. In an embodiment, the new bid amounts may be generated by optimizing revenue for the auctioneer. And campaigns may be updated with new bid amounts for each web page placement at step 306. For instance, an advertisement server may be updated in an embodiment with the new bid amounts for each web page placement for each campaign. When a request may be received by a web page server to serve a web page that may include a web page placement for an advertisement, the web page server may request an advertisement from an advertisement server to send to a web browser operating on a client so that the advertisement may be displayed as part of the web page on a client browser. The advertisement server may use the updated bid amounts to select an advertisement to be sent to the web browser for the web page placement.

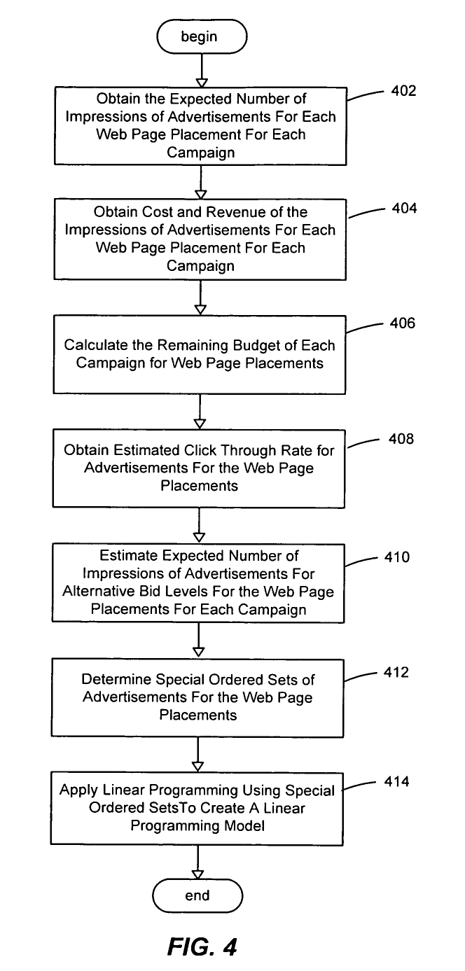

FIG. 4 presents a flowchart for generally representing the steps undertaken in one embodiment for optimizing bids for online advertisement auctions subject to budget constraints by applying linear programming using special ordered sets. In an embodiment, consider Iₖ={i₁, . . . iₘ_{ₖ}} to be the set of web page placements for campaign k, where i=1, . . . , I may represent the web page placements, and k=1, . . . , C may represent advertising campaigns. Each advertising campaign may have a daily budget limit that may be defined as Bₖ. Note that in an embodiment, Bₖ can represent the daily budget for a campaign, where each campaign may be associated with multiple web page placements for advertisements. Thus Bₖ may represent a daily spend limit by a campaign for advertisement impressions displayed through multiple web page placements. If a daily budget limit may not be specified for a campaign, then assume that Bₖ=∞.

There may be a bid amount associated with each web page placement i for a given campaign. In an embodiment, consider j=1, . . . , Nᵢ to define bid levels where each bid level may represent a bid amount for each web page placement for a campaign. A linear programming model may be created for determining bid amounts as further described below.

At step 402, an expected number of impressions of advertisements may be obtained for each web page placement of an advertisement for each campaign for a specific time period. For example, the number of impressions of advertisements for each web page placement for each campaign shown during a previously occurring day may be obtained and the cost and revenue for those impressions may be obtained. The number of impression may be defined as Pᵢⱼ, representing the number of impressions of a web page placement i and bid level j. At step 404, the cost and revenue of the impressions of advertisements may be obtained for each web page placement for each campaign for the specific time period. For instance, the cost and revenue of the impressions of advertisements for each web page placement for each campaign shown during a previously occurring day may be obtained. The cost may be defined as CPCₖ representing the cost per click for advertising campaign k. The revenue may be defined as AVᵢⱼ representing the advertisement value for web page placement i and bid level j.

Once the cost and revenue of the impressions of advertisements may be obtained for each web page placement for each campaign for a time period, the remaining budget of each campaign for web page placements of advertisements may be calculated for the time period at step 406. In an embodiment, a proportional budget may be calculated for each campaign by scaling a known budget over a period of time, such as scaling a monthly budget over a period of 24 hours. Furthermore, calculating a proportional budget may include adjusting a scaled amount by subtracting accrued spending for a given time period.

At step 408, an estimated click-through-rate may be determined for web page placements of advertisements. For a web page placement i of an advertising campaign k, consider CTRᵢₖ to denote the expected click-through-rate (“CTR”). At step 410, an expected number of impressions of advertisements for alternate bid levels may be estimated for web page placements for each campaign. At step 412, special order sets of web page placements of advertisements, defined as δᵢⱼ, may be determined for a web page placement i and a bid level j.

In general, the data collected in steps 402 through 412 may be stored for use by the linear programming analysis engine to apply linear programming using special ordered sets to determine a bid level for web page placement of advertisements to provide optimal revenue for each campaign. At step 414, linear programming using special ordered sets may be applied to determine the bid level for web page placements of advertisements for each campaign to provide optimal revenue to an auctioneer for a time period. In various embodiments, the data collected for the linear programming model may be for any length of period including fifteen minutes, thirty minutes, a period of a day and so forth.

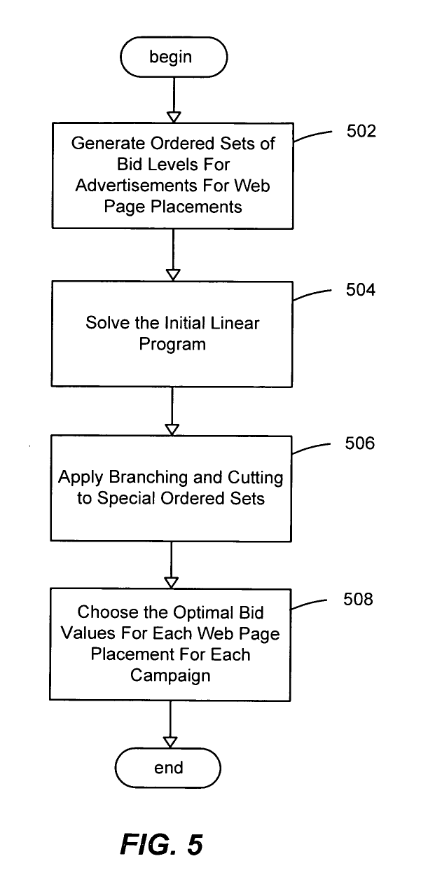

FIG. 5 presents a flowchart for generally representing the steps undertaken in one embodiment for applying linear programming using special ordered sets to determine the bid level for web page placements of advertisements for each campaign to provide optimal revenue. The data collected from steps 402 through 412 for the linear programming model may be read from storage by the linear programming module in order to formulate and build the model as follows. In general, special order sets of web page placements of advertisements, defined as δᵢⱼ, may provide variables for choosing advertisement values such that revenue for an auctioneer may be maximized and spending for each advertising campaign k may be less than the budget for each advertising campaign Bₖ. The advertisement values for web page placements may, therefore, be defined as

$${\sum }_{j} A {V}_{ij} {δ}_{ij} ,$$

and the number of impressions may be defined as

$${\sum }_{j} {P}_{ij} {δ}_{ij} .$$

Linear programming using special order sets may be used to determine the bid level for web page placements of advertisements for each campaign so that advertisement values may be maximized to provide optimal revenue. For special order

$${\sum }_{j} {δ}_{ij} = 1 , ∀ i ,$$

sets defined as a budget defined as

$${\sum }_{i ∈ {I}_{k}} {P}_{ij} \cdot A {V}_{ij} {δ}_{ij} \leq {B}_{k} ,$$

and the cost per click for a advertising

$${\sum }_{i ∈ {I}_{k}} {\sum }_{j} {P}_{ij} \cdot A {V}_{ij} {δ}_{ij} \leq C P {C}_{k} \cdot {\sum }_{i ∈ {I}_{k}} {\sum }_{j} C T {R}_{ik} \cdot {P}_{ij} {δ}_{ij} ,$$

campaign defined as the bid level for web page placements of advertisements for each

$${\sum }_{ij} {L}_{ij} {δ}_{ij} .$$

campaign may be determined by maximizing

In one embodiment, using conventional special ordered sets of type 1 (See J. J. H. Forrest and J. A. Tomlin, “Branch and Bound, Integer and Non-integer Programming”, IBM Research Report RC 22890, Sep. 2, 2003), ordered sets of bid levels for advertisements may be generated for web page placements for each campaign at step 502, and the corresponding linear program may be solved at step 504. At step 506 branching and cutting may be applied to the special ordered sets. Since the special ordered set variables may have a value of zero or one, integer cutting plane techniques together with branch and bound may be applied for the special ordered sets, and solutions may be rapidly obtained. After applying branching and cutting techniques, optimal bid values may be chosen at step 508 for each web page placement for each campaign. In another embodiment, special ordered sets of type 2 (see above reference) may be used. Special ordered sets of type 2 may allow as many as two members of the set to be non-zero, but if there are two such non-zeros, they must be adjacent. In the present context, this may allow the advertisement values and number of impressions to take on values interpolated between the bid values. This may not require any changes to the model formulation, but may allow greater flexibility in the solution. Branching and cutting techniques may also be applied in this embodiment to reach a valid solution. Accordingly, the term “special ordered sets” as used herein may mean either type 1 or type 2 special ordered sets.

Thus, the present invention may use advertising campaign information for auctioned web page placements to optimize bids for online advertising auctions. Forecast data including expected number of impressions, expected cost, expected revenue, estimated click-through rates, and estimated campaign budget remaining, may be used with a predicted number of impressions of advertisements for alternative bid levels to generate special ordered sets of bid levels for web page placements of advertising campaigns. By applying linear programming using special ordered sets to optimize bid levels for web page placements of advertisements for an advertising campaign, an auctioneer's revenue may be optimized. The present invention may also be used to maximize other objectives of an auctioneer, including maximizing the number of impressions for a particular web property, maximize the number of impressions for particular campaigns, and so forth.

As can be seen from the foregoing detailed description, the present invention provides an improved system and method for optimizing online advertising auctions provided by applying linear programming using special ordered sets. Such a system and method may efficiently determine optimal bids in online advertising auctions to optimize revenue of an auctioneer. The system and method may also apply broadly to online advertising applications, for example, to optimize bids for classes of advertisements to be shown to classes of users. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online advertising auctions, comprising:
a model generator for creating a linear programming model including special ordered sets of bids for web page placements of advertisements for advertising campaigns;
a linear programming analysis engine for determining an optimal bid in a special ordered set of bids for web page placements of advertisements for advertising campaigns; and
a server operably coupled to the linear programming analysis engine for providing optimized bids for web page placements of advertisements for advertising campaigns.

2. The system of claim 1 further comprising an ordered set generator for producing the special ordered sets of bids for web page placements of advertising campaigns.

3. The system of claim 1 further comprising a storage operably coupled to the linear programming analysis engine for storing optimized bid amounts for web page placements of advertisements for advertising campaigns.

4. A computer-readable medium having computer-executable components comprising the system of claim 1.

5. A computer-implemented method for online advertising auctions, comprising:
receiving advertising campaign information for auctioned web page placements of advertising campaigns;
determining bid amounts for web page placements of advertising campaigns by applying linear programming using special ordered sets; and
updating the advertising campaign information with bid amounts for web page placements of the advertising campaigns.

6. The method of claim 5 further comprising creating a linear programming model with special ordered sets of bids for the web page placements of advertisements for advertising campaigns.

7. The method of claim 6 wherein creating the linear programming model with special ordered sets of bids comprises determining the special ordered sets of bids for the web page placements of advertisements for advertising campaigns.

8. The method of claim 6 wherein creating the linear programming model with special ordered sets of bids comprises obtaining an expected number of impressions of advertisements for web page placements for advertising campaigns for a time period.

9. The method of claim 6 wherein creating the linear programming model with special ordered sets of bids comprises obtaining an expected cost and revenue of an expected number of impressions of advertisements for web page placements for advertising campaigns for a time period.

10. The method of claim 6 wherein creating the linear programming model with special ordered sets of bids comprises calculating a remaining budget of each advertising campaign for web page placements.

11. The method of claim 6 wherein creating the linear programming model with special ordered sets of bids comprises estimating click through rates for web page placements of advertisements for advertising campaigns for a time period.

12. The method of claim 6 wherein creating the linear programming model with special ordered sets of bids comprises obtaining an expected number of impressions of advertisements for alternative bid levels for web page placements for advertising campaigns for a time period.

13. The method of claim 5 wherein determining bid amounts for web page placements of advertising campaigns by applying linear programming using special ordered sets comprises generating ordered sets of bid levels for web page placements of advertising campaigns.

14. The method of claim 5 wherein determining bid amounts for web page placements of advertising campaigns by applying linear programming using special ordered sets comprises applying branching and cutting techniques to the special ordered sets.

15. The method of claim 5 wherein determining bid amounts for web page placements of advertising campaigns by applying linear programming using special ordered sets comprises choosing the optimal bid values for web page placements of advertising campaigns.

16. A computer-readable medium having computer-executable instructions for performing the method of claim 5.

17. A computer system for online advertising auctions, comprising:
means for receiving advertising campaign information for auctioned web page placements of advertising campaigns; and
means for optimizing revenue of an auctioneer for web page placements of advertising campaigns by applying linear programming using special ordered sets;

18. The computer system of claim 17 wherein means for optimizing revenue of the auctioneer for web page placements of advertising campaigns by applying linear programming using special ordered sets comprises means for optimizing bids for web page placements of advertising campaigns.

19. The computer system of claim 17 wherein means for optimizing revenue of the auctioneer for web page placements of advertising campaigns by applying linear programming using special ordered sets comprises means for choosing optimal bid values for web page placements of advertising campaigns from ordered sets of bid levels for web page placements of advertising campaigns.

20. The computer system of claim 17 wherein means for optimizing revenue of the auctioneer for web page placements of advertising campaigns by applying linear programming using special ordered sets comprises means for creating a linear programming model with special ordered sets of bids for the web page placements of advertisements for advertising campaigns.
